(19) United States
(12) Patent Application Publication
(10) Pub. No.: US 2009/0028579 A1
(43) Pub. Date: Jan. 29, 2009

(54) FIBER OPTIC LINK HAVING AN INTEGRATED LASER AND PHOTODETECTOR CHIP

(75) Inventor: Hongyu Deng, Saratoga, CA (US)

Correspondence Address: Workman Nydegger;1000 Eagle Gate Tower, 60 East South Temple, Salt Lake City, UT, 84111, US

(73) Assignee: FINISAR CORPORATION, Sunnyvale, CA (US)

(21) Appl. No.: 12/147,953

(22) Filed: Jun. 27, 2008

Related U.S. Application Data
(60) Provisional application No. 60/951,366, filed on Jul. 23, 2007.

(51) Int. Cl. H04B 10/12; H04B 10/04; H04B 10/06

(52) U.S. Cl. 398/200; 398/212

(57) ABSTRACT

A fiber optic communications link is disclosed that can include first and second nodes operably connected by a multi-mode optical fiber and that utilizes two distinct optical wavelengths for enabling the bidirectional transfer of data via the optical fiber between the first and second nodes. Each node can include an integrated transmitter/receiver chip that includes a substrate, an optical receiver or transmitter, a filter, and an optical transmitter or receiver. The transmitter of the chip at the first node can be configured to transmit, via the optical fiber, optical data on one wavelength for conversion to an electrical signal by the receiver of the chip at the second node. Simultaneously, the transmitter of the chip at the second node can be configured to transmit, via the optical fiber, optical data on another wavelength for conversion to an electrical signal by the receiver of the chip at the first node.

### CROSS-REFERENCE TO RELATED APPLICATIONS

This application claims the benefit of U.S. Provisional Patent Application Ser. No. 60/951,366, filed Jul. 23, 2007 and entitled FIBER OPTIC LINK HAVING AN INTEGRATED LASER AND PHOTODETECTOR CHIP, the contents of which are herein incorporated by reference in their entirety.

### BACKGROUND OF THE INVENTION

1. The Field of the Invention

The present invention generally relates to fiber optic-based communications systems. In particular, embodiments of the present invention relate to a simplified assembly for establishing a fiber optic link between communications devices.

2. The Relevant Technology

Computing and networking technology has transformed our world. As the amount of information communicated over networks steadily increases, high speed transmission becomes ever more critical. Many high speed data transmission networks rely on communications modules, such as optical transceivers, optical transponders, and similar devices, for facilitating transmission and reception of digital data embodied in the form of optical signals over optical fibers. Optical networks are thus found in a wide variety of high speed applications ranging from modest Local Area Networks (“LANs”) to backbones that define a large portion of the infrastructure of the Internet.

Typically, data transmission in such networks is implemented by way of an optical transmitter (also referred to as an “electro-optic transducer”), such as a laser or Light Emitting Diode (“LED”). The electro-optic transducer emits light when current is passed through it, the intensity of the emitted light being a function of the magnitude of the current. Data reception is generally implemented by way of an optical receiver (also referred to as an “optoelectronic transducer”), an example of which is a photodiode. The optoelectronic transducer receives light and generates a current, the magnitude of the generated current being a function of the intensity of the received light.

Various other components are also employed by the optical transceiver to aid in the control of the optical transmit and receive components, as well as the processing of various data and other signals. For example, the optical transmitter is typically housed in a transmitter optical subassembly (“TOSA”), while the optical receiver is housed in a separate receiver optical subassembly (“ROSA”). The transceiver also typically includes a driver (e.g. referred to as a “laser driver” when used to drive a laser signal) configured to control the operation of the optical transmitter in response to various control inputs and an amplifier (e.g. often referred to as a “post-amplifier”) configured to amplify the channel-attenuated received signal prior to further processing. A controller circuit (hereinafter referred to as the “controller”) controls the operation of the laser driver and post-amplifier.

As optical transmission speed provided by transceivers and other communications modules rises, a recurrent need for a reduction in the space occupied by the optical transmitter and receiver of an optical subassembly is realized. This in turn enables relatively more optical transmitters and receivers to be disposed in a given volume, thereby increasing the overall speed and efficiency of the data transfer system. In addition, an ever-present need exists for simplifying both the construction and manufacture of fiber optic links in order to increase ease of manufacturability while reducing overall cost.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF THE INVENTION

These and other limitations are overcome by embodiments of the invention which relate to systems and methods for optically communicating between devices in a network. More particularly, embodiments of the invention relate to a fiber optic communications link configured to simultaneously communicate bidirectionally over a unitary optical fiber. The use of such a fiber optic link in a network can enable an increase in the overall speed and efficiency of the network and/or increase the ease of manufacturability while reducing overall cost of the fiber optic link.

An example fiber optic communications link according to embodiments of the invention can include a multi-mode optical fiber, a first node operably connected to the optical fiber, and a second node operably connected to the first node via the optical fiber. The first node can be configured to simultaneously receive a first optical signal having a first wavelength from the second node via the optical fiber and transmit a second optical signal having a second wavelength to the second node via the optical fiber, while the second node can be configured to simultaneously transmit the first optical signal to the first node and receive the second optical signal from the first node.

According to embodiments of the invention, each of the first and second node can include an electrical interface configured to operably connect the node to a corresponding host device and a transmitter and receiver optical subassembly (“TROSA”) operably interconnected between the corresponding electrical interface and the optical fiber. Each of the TROSAs can define a housing for a corresponding integrated transmitter and receiver chip included in each of the first and second nodes.

For instance, a first integrated transmitter and receiver chip included in the first node can include a substrate, a photodiode, an optical filter, and a laser arranged in a stacked configuration, the photodiode being configured to convert the first optical signal to an electrical signal which can be forwarded to a first host device via a first electrical interface, the optical filter being configured to allow transmission therethrough of the first optical signal, and the laser being configured to emit the second optical signal. The second integrated transmitter and receiver chip included in the second node can include a substrate, a laser, an optical filter, and a photodiode also arranged in a stacked configuration, the laser being configured to emit the first optical signal, the optical filter being configured to allow transmission therethrough of the first optical signal, and the photodiode being configured to emit the second optical signal.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a portion of an optical transceiver module that can serve as an example environment for practice of embodiments of the invention;

FIG. 2A is a simplified block diagram of a fiber optic communications link according to embodiments of the invention;

FIG. 2B is a simplified view of the fiber optic communications link of FIG. 2A, according to embodiments of the invention; and

FIG. 3 is a simplified block diagram showing two integrated optical transmitter/receiver chips included in the fiber optic communication links shown in FIGS. 2A and 2B.

### DETAILED DESCRIPTION OF THE PREFERRED EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

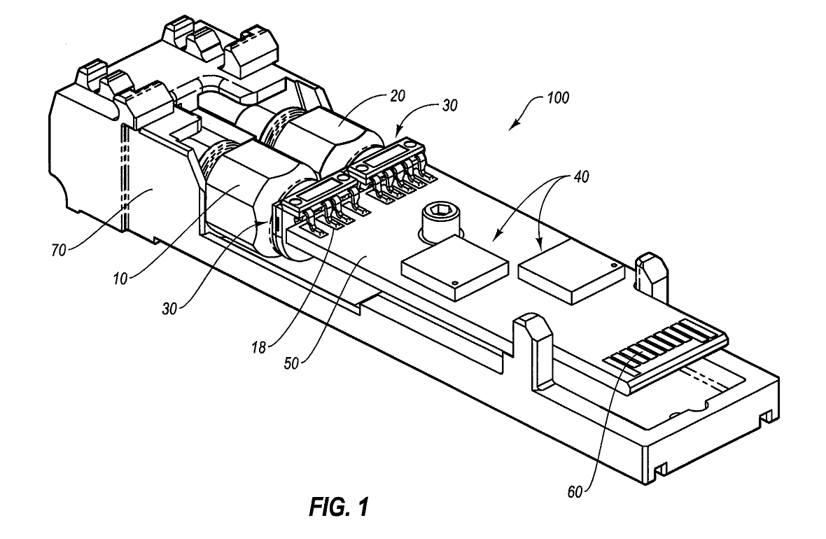

FIGS. 1-3 depict various embodiments of the present invention, which is generally directed to an optical fiber-based communications link that incorporates an optical transmitter and receiver integrated into a single chip, thereby increasing device density within an optical subassembly, for instance, and simplifying manufacture of the link.

Note at the outset that the discussion to follow regarding embodiments of the invention should not be construed as limiting the application to such embodiments. Indeed, devices and components apart from optical subassemblies and optical transceiver modules utilized in fiber optic links that employ laser devices and photodetectors can also benefit from the teachings to be discussed herein.

### 1. Example Operating Environments

Reference is first made to FIG. 1, which depicts a perspective view of an optical transceiver module (“transceiver”), generally designated at 100, for use in transmitting and receiving optical signals in connection with an external host that is operatively connected in one embodiment to a communications network (not shown). Optical transceiver modules, such as that illustrated in FIG. 1 and described below, or other communications modules can be included in an optical fiber-based communications link (“fiber optic link”) that incorporates embodiments of the invention for the transfer of data between two or more points as described by example below.

As depicted, the transceiver 100 disclosed in FIG. 1 includes various components, including a first optical subassembly (“OSA”) 10, a second OSA 20, electrical interfaces 30, various electronic components 40, and a printed circuit board (“PCB”) 50. In detail, two electrical interfaces 30 can be included in the transceiver 100, one each used to electrically connect the OSAs 10 and 20 to a plurality of conductive pads 18, located on the PCB 50. The electronic components 40 can also be operably attached to the PCB 50. An edge connector 60 located on an end of the PCB 50 can enable the transceiver 100 to electrically interface with a host (not shown). As such, the PCB 50 can facilitate electrical communication between the OSAs 10 and 20, and the host. In addition, the above-mentioned components of the transceiver 100 can be partially housed within a shell 70. Though not shown, the shell 70 can cooperate with a housing portion to define a covering for the components of the transceiver 100.

While discussed in some detail here, the optical transceiver 100 is described by way of illustration only, and not by way of restricting the scope of the invention. As mentioned above, the optical transceiver 100 may be suitable for optical transmission and reception at a variety of per-second data rates, including, but not limited to 1 Gigabit per second (“G”), 2 G, 2.5 G, 4 G, 8 G, 10 G, or higher rates. Furthermore, the principles of the present invention can be implemented in optical transmitters and transceivers of shortwave and long wave optical transmission and any form factor such as XFP, SFP, and SFF, without restrictions. Moreover, embodiments of the invention are not limited to an optical transceiver environment at all, but can alternately or additionally be implemented in other environments, such as optical transponder or other environments.

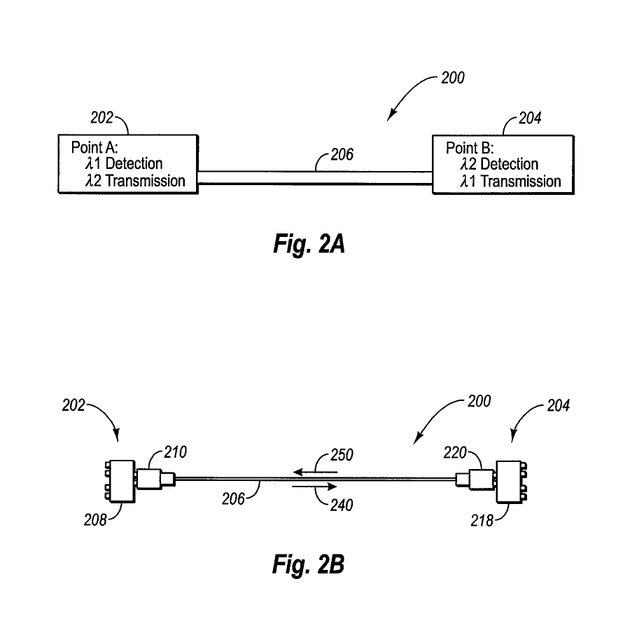

Reference is now made to FIG. 2A in describing yet another possible environment for practice of embodiments of the invention. In particular, FIG. 2A shows an active cable system 200 that defines a fiber-optic-based communications link between a first node 202 (“Point A”) and a second node 204 (“Point B”) via an optical fiber 206. Note that the optical fiber 206 establishing the link between the first and second nodes 202 and 204 can be a unitary multi-mode optical fiber. Note also that the system 200 can utilize two distinct optical wavelengths for enabling the simultaneous bidirectional transfer of data between the first node 202 and the second node 204: 850 nm signals in one direction, and 980 nm signals in the opposite direction. Note that the particular wavelengths used for the transfer of optical signal data between the nodes can be varied from what is explicitly described herein. For instance, the two optical signal wavelengths could alternately be: 780 nm and 850 nm, 780 nm and 980 nm, 850 nm and 1310 nm, 980 nm and 1310 nm, 1310 nm and 1490 nm, or the like.

Reference is now made to FIG. 2B, which discloses further details of the active cable system 200 shown in FIG. 2A. In detail, FIG. 2B depicts the active cable assembly 200 of FIG. 2A, including the first node 202 and the second node 204 operably interconnected to one another by the multi-mode optical fiber 206. As shown, the first node 202 can include an electrical interface 208 for enabling the first node 202 to electrically and operably connect with a host device (not shown). A transmitter and receiver optical subassembly (“TROSA”) 210 can be operably interconnected between the electrical interface 208 and the optical fiber 206 and can be configured to convert data signals between an electrical and optical format. As such, electrical data signals forwarded from the host device via the electrical interface 208 can be converted within the TROSA 210 to an optical format before being launched onto the optical fiber 206, such as an optical data signal 240 shown in FIG. 2B. Likewise, optical signals received by the TROSA 210 from the optical fiber 206, such as an optical data signal 250, can be converted within the TROSA 210 to electrical data signals before being forwarded to the host device via the electrical interface 202.

The second node 204 can similarly include an electrical interface 218 and a TROSA 220 that operate substantially similar to their respective counterparts included in the first node 202 as just described. In particular, the electrical interface 218 can enable the second node 204 to electrically and operably connect with a second host device (not shown). The TROSA 220 can be operably interconnected between the electrical interface 218 and the optical fiber 206 to convert data signals between an electrical and optical format. For instance, electrical data signals forwarded from the second host device via the electrical interface 218 can be converted within the TROSA 220 to an optical format before being launched onto the optical fiber 206 as optical data signal 250. Likewise, the optical signal 240 received by the TROSA 220 from optical fiber 206 can be converted within the TROSA 220 to electrical data signals before being forwarded to the second host device via the electrical interface 218.

The active cable system 200 shown in FIGS. 2A and 2B can be implemented in a cable-type configuration, also referred to herein as an “active cable” assembly. The active cable assembly can offer increased flexibility for optical communication implementations as compared to conventional fiber optic links.

It will be appreciated by those skilled in the art, with the benefit of the present disclosure, that either or both of the first and second OSAs 10 and 20 in FIG. 1 can include an integrated transmitter/receiver as will be described below in accordance with embodiments of the invention. However, the discussion to follow is primarily directed to inclusion of integrated transmitter/receiver chips in the TROSA(s) of an active cable assembly, such as the active cable system 200 shown in FIGS. 2A and 2B. As such, the discussion to follow serves as one example implementation of embodiments of the invention. However, it should be appreciated that these implementations are merely examples of the invention, and it will be understood that these specific environments are only a few of countless architectures in which the principles of the invention may be employed. As previously stated, the principles of the invention are not intended to be limited to any particular environment.

### 2. Integrated Optical Transmitter and Receiver

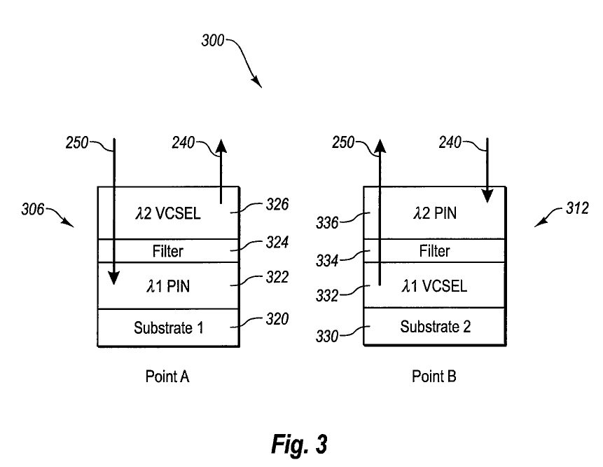

Reference is now made to FIG. 3. In general, the operating environment described above, i.e., that of the active cable assembly 200 shown in FIGS. 2A and 2B, is representative of embodiments of the invention in which an active cable system including integrated optical transmitter and receiver chips can be included.

In detail, FIG. 3 abstractly discloses a fiber optic link, generally designated at 300, including an integrated transmitter/receiver chip (“chip”) 306 located at point A in the link and an integrated transmitter/receiver chip (“chip”) 312 located at point B. For purposes of this discussion, point A may refer to disposal of the chip 30 within the TROSA 210 of the first node 202, while point B may refer to disposal of the chip 312 within the TROSA 220 of the second node of the active cable system 200 of FIG. 2B.

Note that the spatial separation of points A and B can be relatively close, such as in the same room—as in the case of an active cable system having a length of 10 meters or less—or relatively more remote, as in the case of separations of about 200 meters, including other spatial separations in between these distances as well. Further, it is appreciated that a communications network can include one or many of such fiber optic links configured as described herein. Also, though disclosed herein as operably interacting with one another, the chips 306 and 312 to be described below can also be configured to communicate with standard OSAs known in the art.

As already indicated, the chips 306 and 312 can be included as components within the respective TROSAs 210 and 220 of the active cable system 200 and operably interconnected to one another via the optical fiber 206, disclosed in FIGS. 2A and 2B. As such, the TROSAs 210 and 220 can define housings in which the chips 306 and 312 are housed at either node 202, 204 of the active cable system 200. Also as discussed, the fiber 206 can include a unitary multi-mode fiber capable of simultaneously carrying optical signals having respectively differing wavelengths. Alternately or additionally, the fiber 206 can include glass fiber, low cost plastic optical fiber, an optical wave-guide, or the like. Alternately or additionally, the fiber 206 can be omitted altogether for free space communications. In embodiments described in greater detail below, the fiber 206 can alternately include a plurality of parallel fibers.

Generally, each integrated chip 306 and 312 can include both an optical transmitter and optical receiver arranged in a space-saving, stacked configuration. With inclusion of a transmitter and receiver, each of the integrated chips 306 and 312 can be configured to simultaneously receive one optical signal having one wavelength and transmit another optical signal having a different wavelength. Further, the stacked transmitter and receiver can be configured to allow optical signals to pass through the stack without interference during OSA operation, as will be explained.

In greater detail, the chip 306 located at the first node 202 (point A) can include a substrate 320 composed of a suitable material(s), such as GaAs or InP. A PIN-type photodiode (“PD”) 322 or other suitable photodetector can be positioned atop the substrate 320 and can be configured for sensitivity in detecting optical signals within a first predetermined range of wavelengths, referred to herein as λ1. In the present embodiment, for instance, the PD 322 can be configured for detection of optical signals having a wavelength of approximately 980 nanometers (“nm”) corresponding to the first predetermined wavelength range λ1. Note, however, that the PD 322 could be configured so as to be sensitive to various other wavelengths and/or wavelength ranges.

The PD 322 can be disposed on an InP substrate and can include an n-type InP bottom buffer layer, an undoped InGaAsP layer tuned to the desired wavelength, a p-type InP layer, and an InGaAs top contact layer. Note that a PIN PD formed on other substrates, such as a GaAs substrate, can have a similar layer structure, with the layer compositions being adjusted to match the substrate lattice constant.

An optical isolation filter 324 can be positioned atop the PD 322 and can be configured to pass optical signals having a wavelength within a predetermined range of wavelengths, which may correspond to the first predetermined range of wavelengths λ1. For instance, the filter 324 can be configured to pass optical signals having wavelengths of at least 920 nm. Alternately or additionally, the filter 324 can be configured to pass optical signals of other specific wavelengths and wavelength ranges, according to the particular configuration of the PD 322 residing below the filter.

In greater detail, the filter 324 can be a two-way filter configured to block optical signals within a second predetermined range of wavelengths, referred to herein as λ2. For instance, λ2 may include wavelengths of approximately 850 nm. Thus, the filter 324 can block λ2 (e.g., 850 nm in the present example) optical back-emission from the back side of VCSEL 326 so as to prevent back-emission light from reaching the λ1 PD 322, in order to prevent the introduction of cross talk between the two optical signal wavelengths λ1 (e.g., 980 nm in the present example) and λ2. At the same time, the filter 324 can be configured to allow the optical signal having the λ1 wavelength (e.g., 980 nm in the present example) to pass to reach the λ1 PIN PD 322.

Atop the filter 324 a laser 326 or other suitable light source can be positioned. As disclosed in FIG. 3, the laser 326 can be a VCSEL, but other suitable laser types could alternatively be used. The laser 326 can be configured to emit optical signals of the second predetermined wavelength or wavelength range λ2. In the present embodiment, for instance, the laser 326 can be configured to emit optical signals having a wavelength of approximately 850 nm. However, other wavelength emission configurations of the laser 326 are alternately or additionally possible.

In the example disclosed in FIG. 3, the laser 326 is a VCSEL, including an active region sandwiched by top and bottom distributed Bragg reflectors (“DBRs”). The active region can include multiple quantum wells of various compositions e.g. InGaAs, InAl, GaAs, InGaAsN, InGaAsNSb, designed to emit light at the desired wavelength λ2. The DBRs are typically alternating layers of quarter-wave-thick AlGaAs, InGaAsP, and other materials, designed to have very high reflectivity at the desired wavelength. Of course, other laser and/or VCSEL structural configurations can alternately or additionally be employed.

As indicated by FIG. 3, the laser 326 can also be configured to enable the passage therethrough of optical signals. For instance, the laser 326 can be configured to have a transmittance that allows the passage therethrough of at least optical signals in the first predetermined wavelength range λ1 (e.g., in the range of about 980 nm in the present example) without significant absorption or reflection. In an example embodiment, the laser can be configured to pass all optical signals therethrough. Or, in another example embodiment the laser can be configured to pass optical signals of only a predetermined wavelength range(s), such as wavelength range λ1.

FIG. 3 shows that the chip 312 disposed at the second node 204 (point B) can include components corresponding to those of the chip 306, and as such the components can share many similarities to those already described, subject to the differences as described below. Specifically, the OSA 312 can include a substrate 330 composed of GaAs, InP, or other suitable material having a laser 332 or other suitable light source disposed thereon. In the present embodiment, the laser 332 can be a VCSEL configured to emit an optical signal having a wavelength within the first predetermined wavelength range λ1, which can be approximately 980 nm in the present example. However, other wavelengths are alternately or additionally possible. An example of an integrated chip system where the optical transmitter and receiver components are configured to operate at other optical wavelengths can be found in U.S. patent application Ser. No. 12/147,852, filed Jun. 27, 2008, and entitled INTEGRATED LASER AND PHOTODETECTOR CHIP FOR AN OPTICAL SUBASSEMBLY, which is herein incorporated by reference in its entirety.

An optical isolation filter 334 can be included atop the laser 332 and can be configured to enable optical signals within a predetermined wavelength range, which may correspond to the first predetermined wavelength range λ1, to pass therethrough. For instance, the filter 334 can be configured to pass optical signals having a wavelength of 920 nm or greater, although this value is given by way of example only. As such, optical signals within the first wavelength range λ1 (e.g., 980 nm in the present example) produced by the VCSEL 332 may be allowed to pass through the filter 334 when produced. At the same time, the two-way filter 334 can prevent any residual light within the second predetermined wavelength range λ2 that passes through the PD 336 disposed above from being transmitted to the laser 332 and causing any noise problems.

A PIN-type PD 336 can be positioned atop the filter 334 of the chip 312. The PD 336 can be configured so as to be sensitive to optical signals within the second predetermined wavelength range λ2, such as about 850 nm in the present example. The PD 336, like the laser 326 of the OSA 306, can be further configured with a transmittance that enables the passage of optical signals of other wavelengths (e.g., λ1) to pass therethrough without significant absorption or reflection. For instance, in the present example, optical signals having a 980 nm wavelength emitted by the laser 332, disposed below the PD 336 as shown in FIG. 3, may be allowed to pass through the PD 336. The PD 336 can have a similar structure as PD 322, but with layer compositions adjusted so as to match the substrate lattice content of the substrate 330 on which the PD 336 is disposed.

Operation of the chips 306 and 312 may be such that optical signals of distinct wavelengths can be simultaneously transferred therebetween. Indeed, the present example configuration is such that either or both of the chips 306 and 312 can both send and receive optical signals simultaneously, as is explained below.

During operation of the fiber optic link defined by the active cable system 200, the laser 326 of the chip 306 of the first node can emit an optical signal 240 having a wavelength λ2 of approximately 850 nm. The data signal 240 can be encoded with data received from the electrical interface 208 of the first node 202, the data having been forwarded as an electrical signal by the operably connected host device (not shown), the electrical interface 208 operably connecting the integrated chip 306 to the host device. After emission by the laser 326, the signal 240 can exit the TROSA 210 via an optical pathway including standard light conditioning components including an isolator, lens, etc. (not shown). The λ2 signal 240 can then be directed into the fiber 206 and be transmitted therein to the TROSA 220 of the second node 204, where it can be passed through standard light conditioning components until received by the PD 336 disposed at the top of the stacked components of the chip 312, from the perspective seen in FIG. 3.

As discussed above, the PD 336 can be configured to receive the λ2 optical signal 240 and convert it to an electrical signal representative of the data encoded in the signal. The electrical signal can then be forwarded to the electrical interface 218 of the second node 204, then on to the operably connected second host system (not shown) for use, the electrical interface 218 operably connecting the integrated chip 312 to the second host device.

In an analogous manner, the laser 332 of the chip 312 of the second node TROSA 220 can produce an optical data signal 250 having a λ1 wavelength of approximately 980 nm. The λ1 data signal 250, having been encoded with data received in electrical format from the second host device (not shown), via the electrical interface 218, can be emitted from the laser 332 in an upward direction, according to the orientation shown in FIG. 3, so as to pass through the filter 334, which as described can be configured to allow its passage. The λ1 signal 250 can then pass through the PD 336, which can also be configured to enable passage of the signal therethrough, before exiting the TROSA 220 along an optical pathway and entering the fiber 206.

The λ1 data signal 250 can be transmitted by the fiber 206 to the TROSA 210 at the first node 202, where it is received by the TROSA 210 via its optical pathway. The λ1 signal 250 can then be incident on the laser 326, which may be transmissive of the λ1 signal so as to enable it to pass through. The λ1 signal 250 can then pass through the filter 324, configured as described to transmit signals having wavelengths of 920 nm or above. After passage through the filter, the λ1 optical signal 250 can be received by the PD 322, where the λ1 optical signal can be converted into an electrical signal representative of the data encoded in the signal. The electrical signal can then be forwarded to the electrical interface 208 of the first node 202, then on to the operably connected host system (not shown) for use.

As mentioned, the above optical signal transmission and reception operations of each integrated chip 306 and 312 can be performed simultaneously, given that the optical data signals 240 and 250 have respectively differing wavelengths. As such, it is appreciated that the TROSAs could be configured for simultaneous operation with optical signals having other wavelengths than what has been described above. The stacked laser and photodiode chip configuration as described herein can further significantly reduce the cost and complexity of a compact OSA by virtue of the integrated design and structure of the chip. Such compact OSAs may have utility, for instance, in fiber-to-the home (“FTTH”) and fiber-to-the wherever (“FTTX”) fiber optic applications.

It is noted that, though not explicitly shown, each TROSA 210 and 220 can include a lens, an optical isolator, and/or an optical attenuator, each configured so as to acceptably condition the optical signals of both wavelengths used in connection with the TROSAs, although this is not required in all embodiments.

Practice of embodiments of the invention can enable the establishment of a fiber optic link using a unitary, multi-mode (or other) optical fiber instead of a single-mode fiber or multiple optical fibers. This can not only substantially save on optical fiber costs, but cut in half the number of optical alignments that must be made over a system using dual optical fibers.

Embodiments of the invention have been described in the context of active cable systems that include a unitary optical fiber having an integrated transmitter and receiver chip at either end. Alternately or additionally, active cable systems according to embodiments of the invention can include parallel optical fibers having arrays of integrated transmitter and receivers (e.g., fabricated as a single chip) at each end of the parallel optical fibers. In this example, each fiber of the parallel optical fibers facilitates bidirectional optical communication between an integrated transmitter and receiver in the array at one end of the fiber with a corresponding integrated transmitter and receiver in the array at the other end of the fiber.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fiber optic communications link, comprising:
a multi-mode optical fiber;
a first node operably connected with the optical fiber and configured to simultaneously receive via the optical fiber a first optical signal having a first wavelength and transmit via the optical fiber a second optical signal having a second wavelength; and
a second node operably connected to the first node via the optical fiber and configured to simultaneously transmit to the first node via the optical fiber the first optical signal and receive from the first node via the optical fiber the second optical signal.

2. The fiber optic communications link as defined in claim 1, further comprising:
a first integrated optical transmitter and optical receiver chip included in the first node and configured to simultaneously receive the first optical signal and transmit the second optical signal; and
a second integrated optical transmitter and optical receiver chip included in the second node and configured to simultaneously transmit the first optical signal and receive the second optical signal.

3. The fiber optic communications link as defined in claim 2, further comprising:
a first electrical interface included in the first node and configured to operably connect the first integrated chip to a first host device; and
a second electrical interface included in the second node and configured to operably connect the second integrated chip to a second host device.

4. The fiber optic communications link as defined in claim 3, further comprising:
a first transmitter and receiver optical subassembly included in the first node and operably interconnected between the first electrical interface and the optical fiber, the first optical subassembly defining a housing for the first integrated chip; and
a second transmitter and receiver optical subassembly included in the second node and operably interconnected between the second electrical interface and the optical fiber, the second optical subassembly defining a housing for the second integrated chip.

5. The fiber optic communications link as defined in claim 2, wherein:
the first integrated chip includes:
a first substrate;
a first optical receiver disposed atop the first substrate, the first receiver configured to receive and convert the first optical signal to an electrical signal;
a first optical filter disposed atop the first receiver between the optical fiber and the first receiver, the first filter allowing transmission of the first optical signal to the first receiver; and
a first optical transmitter disposed atop the first filter, the first transmitter configured to emit the second optical signal; and
the second integrated chip includes:
a second substrate;
a second optical transmitter disposed atop the second substrate, the second transmitter configured to emit the first optical signal;
a second optical filter disposed atop the second transmitter between the optical fiber and the second transmitter, the second filter allowing transmission therethrough of the first optical signal emitted by the second transmitter; and
a second optical receiver disposed atop the second filter, the second receiver configured to receive and convert the second optical signal to an electrical signal.

6. The fiber optic communications link as defined in claim 5, wherein:
the first transmitter is further configured to allow transmission therethrough without significant absorption or reflection of the first optical signal to be received by the first receiver; and
the second receiver is further configured to allow transmission therethrough without significant absorption or reflection of the first optical signal emitted by the second transmitter.

7. The fiber optic communications link as defined in claim 1, wherein:
the first wavelength is approximately 980 nanometers and the second wavelength is approximately 850 nanometers; or
the first wavelength is approximately 1490 nanometers and the second wavelength is approximately 1310 nanometers; or
the first wavelength is approximately 850 nanometers and the second wavelength is approximately 780 nanometers.

8. A fiber optic communications link, comprising:
a multi-mode optical fiber;
a first node operably connected to the optical fiber and having:
a first electrical interface for enabling the first node to electrically and operably connect with a first host device; and
a first optical subassembly interconnected between the first electrical interface and the optical fiber and configured to convert data signals between an electrical format and an optical format; and
a second node operably connected to the first node via the optical fiber and having:
a second electrical interface for enabling the second node to electrically and operably connect with a second host device; and
a second optical subassembly interconnected between the second electrical interface and the optical fiber and configured to convert data signals between an electrical format and an optical format;
wherein the first optical subassembly and second optical subassembly utilize two distinct wavelengths to enable the simultaneous bidirectional transfer of data between the first optical subassembly and second optical subassembly via the optical fiber.

9. The fiber optic communications link of claim 8, wherein:
the first optical subassembly converting data signals between an electrical format and an optical format includes:
converting electrical data signals received from the first host device via the first electrical interface to a first optical signal having a first wavelength for transmission to the second optical subassembly via the optical fiber; and
converting a second optical signal having a second wavelength received from the second optical subassembly via the optical fiber to electrical data signals for transmission to the first host device via the first electrical interface; and
the second optical subassembly converting data signals between an electrical format and an optical format includes:
converting electrical data signals received from the second host device via the second electrical interface to the second optical signal for transmission to the first optical subassembly via the optical fiber; and
converting the first optical signal received from the first optical subassembly via the optical fiber to electrical data signals for transmission to the second host device via the second electrical interface.

10. The fiber optic communications link of claim 8, further comprising one or more light conditioning components included in the first optical subassembly, the second optical subassembly, or any combination thereof.

11. The fiber optic communications link of claim 10, wherein the one or more light conditioning components include a lens, an optical isolator, an optical attenuator, or any combination thereof.

12. The fiber optic communications link of claim 8, wherein:
the first optical subassembly defines a housing for a first integrated optical transmitter and optical receiver chip configured to simultaneously receive a first optical signal having a first wavelength and transmit a second optical signal having a second wavelength; and
the second optical subassembly defines a housing for a second integrated optical transmitter and optical receiver chip configured to simultaneously receive the second optical signal and transmit the first optical signal.

13. The fiber optic communications link of claim 12, wherein:
the first integrated chip includes a first substrate, a first photodiode, a first filter, and a first laser arranged in a stacked configuration; and
the second integrated chip includes a second substrate, a second laser, a second filter, and a second photodiode arranged in a stacked configuration.

14. The fiber optic communications link of claim 13, wherein:
the first laser is configured to emit the second optical signal for transmission to the second integrated chip via the optical fiber;
the second photodiode is configured to convert the second optical signal emitted by the first laser and received by the second integrated chip via the optical fiber to an electrical data signal;
the second laser is configured to emit the first optical signal for transmission to the first integrated chip via the optical fiber;
the first photodiode is configured to convert the first optical signal emitted by the second laser and received by the first integrated chip via the optical fiber to an electrical data signal; and
the second filter, the second photodiode, the first laser, and the first filter are configured to be transmissive of optical signals having the first wavelength, including the first optical signal, to enable transmission of the first optical signal from the second laser to the first photodiode.

15. The fiber optic communications link of claim 14, wherein:
the first filter is further configured to block a back-emission optical signal having the second wavelength and emitted from the back of the first laser from reaching the first photodiode; and
the second filter is further configured to block a residual optical signal having the second wavelength and not absorbed by the second photodiode from reaching the second laser.

16. A fiber optic communications link, comprising:
a multi-mode optical fiber;
a first node operably connected with the optical fiber, the first node including:
a first integrated optical transmitter and optical receiver chip, including:
a first substrate;
a first PIN-type photodiode disposed atop the first substrate, the first photodiode configured to convert a second optical signal received via the optical fiber and having a second wavelength to an electrical signal;
a first optical filter disposed atop the first photodiode, the first filter allowing transmission of the second optical signal to the first photodiode; and
a first VCSEL laser disposed atop the first filter, the first laser configured to emit a first optical signal having a first wavelength; and
a second node operably connected to the first node via the optical fiber, the second node including:
second integrated optical transmitter and optical receiver chip, including:
a second substrate;
a second VCSEL laser disposed atop the second substrate, the second laser configured to emit the second optical signal, the second optical signal being transmitted to the first node via the optical fiber;
a second optical filter disposed atop the second VCSEL laser, the second filter allowing transmission therethrough of the second optical signal emitted by the second VCSEL laser; and
a second PIN-type photodiode disposed atop the second filter, the second photodiode configured to receive the first optical signal emitted by the first laser via the optical fiber and convert the first optical signal to an electrical signal, the second photodiode further configured to allow transmission of the second optical signal emitted by the second laser.

17. The fiber optic communications link as defined in claim 16, further comprising:
a first electrical interface included in the first node and configured to operably connect the first integrated chip to a first host device; and
second electrical interface included in the second node and configured to operably connect the second integrated chip to a second host device.

18. The fiber optic communications link as defined in claim 16, wherein:
the first wavelength is approximately 850 nanometers and the second wavelength is approximately 980 nanometers; or
the first wavelength is approximately 1310 nanometers and the second wavelength is approximately 1490 nanometers; or
the first wavelength is approximately 780 nanometers and the second wavelength is approximately 850 nanometers.

19. The fiber optic communications link as defined in claim 16, wherein the first photodiode, second photodiode, or both, includes one or more of:
an n-type bottom buffer layer;
an undoped layer tuned to the first wavelength for the first photodiode or to the second wavelength for the second photodiode;
a p-type layer; and
a top contact layer.

20. The fiber optic communications link as defined in claim 16, wherein the first laser, second laser, or both, includes:
a bottom distributed Bragg reflector including alternating layers of quarter-wave-thick semiconductor layers designed to have high reflectivity at: the first wavelength for the first laser; or the second wavelength for the second laser;
an active region including a plurality of quantum wells; and
a top distributed Bragg reflector including alternating layers of quarter-wave-thick semiconductor layers designed to have high reflectivity at: the first wavelength for the first optical transmitter; or the second wavelength for the second optical transmitter.
